(19) United States
(12) Patent Application Publication
(10) Pub. No.: US 2022/0065015 A1
(43) Pub. Date: Mar. 3, 2022

(54) COOKING APPLIANCE WITH DOOR COUNTERWEIGHT

(71) Applicant: ILLINOIS TOOL WORKS INC., Glenview, IL (US)

(72) Inventor: Harrison J. JACKSON, Catonsville, MD (US)

(21) Appl. No.: 17/401,496

(22) Filed: Aug. 13, 2021

Related U.S. Application Data
(60) Provisional application No. 63/072,462, filed on Aug. 31, 2020.

(51) Int. Cl. E05D 13/00; F24C 15/02

(52) U.S. Cl. CPC E05D 13/14; E05Y 2900/308; F24C 15/02

(57) ABSTRACT

A cooking appliance includes a housing incorporating a cooking chamber accessible via a chamber opening, and a door mounted adjacent the chamber opening and movable between a closed position and an open position relative to the chamber opening. A cam arm is connected to the door and extends within the housing, wherein the cam arm moves with the door. A counterweight is disposed within the housing and external of the cooking chamber, the counterweight mounted for movement along a set path. A portion of the cam arm is configured to movably interact with the counterweight such that the counterweight is raised when the door moves from the closed position to the open position.

### TECHNICAL FIELD

This application relates generally to cooking appliances, such as ovens and ranges and, more specifically, to a cooking appliance with an access door having an associated counterweight.

### BACKGROUND

Existing oven or range counterbalances are either springs (compression or tension) or weights. Heavy weights tend to be used on commercial grade, heavy duty ranges. Weight systems are viewed as most reliable, as spring systems tend to lose tension, are affected by heat, and experience faster wear of small pins/rollers. Existing known weight systems are permanently attached to the door arms. This arrangement requires relatively large space envelopes for a second rotating mass and the door attachment thereto, and increases difficulty in aligning, installing, and removing doors.

Accordingly, it would be advantageous to provide an improved counterweight arrangement for cooking appliances, such as ovens and ranges.

### SUMMARY

In one aspect, a cooking appliance includes a housing with a cooking chamber accessible via a chamber opening. A door is mounted adjacent the chamber opening and is movable between a closed position closing the chamber opening and an open position in which items may be moved into and out of the cooking chamber, wherein the door is mounted to the housing for pivoting movement about a substantially horizontal pivot axis between the closed position and the open position. A cam arm is connected to the door and extends within the housing, wherein the cam arm includes an inner end that pivots about the substantially horizontal pivot axis when the door moved between the closed position and the open position. A counterweight disposed within the housing and external of the cooking chamber, the counterweight mounted for linear movement along a path alongside the cooking chamber. A portion of the cam arm is configured to movably interact with the counterweight such that the counterweight is raised when the door moves from the closed position to the open position.

In another aspect, a cooking appliance includes a housing with a cooking chamber accessible via a chamber opening. A door is mounted adjacent the chamber opening and is movable between a closed position closing the chamber opening and an open position in which items may be moved into and out of the cooking chamber, wherein the door is mounted to the housing for pivoting movement between the closed position and the open position. A cam arm is connected to the door and extends within the housing. A counterweight disposed within the housing and external of the cooking chamber, the counterweight mounted for linear movement along a path alongside the cooking chamber. A portion of the cam arm is configured to movably interact with the counterweight such that the counterweight is raised when the door moves from the closed position to the open position.

In a further aspect, a cooking appliance includes a housing incorporating a cooking chamber accessible via a chamber opening, and a door mounted adjacent the chamber opening and movable between a closed position and an open position relative to the chamber opening. A cam arm is connected to the door and extends within the housing, wherein the cam arm moves with the door. A counterweight disposed within the housing and external of the cooking chamber, the counterweight mounted for movement along a set path. A portion of the cam arm is configured to movably interact with the counterweight such that the counterweight is raised when the door moves from the closed position to the open position.

The details of one or more embodiments are set forth in the accompanying drawings and the description below. Other features, objects, and advantages will be apparent from the description and drawings, and from the claims.

### BRIEF DESCRIPTION OF THE DRAWINGS

FIG. 1 is a perspective schematic depiction of a cooking appliance;

FIG. 2 shows part of a cooking appliance with external shell of the housing removed;

FIG. 3 is to plan schematic view of the cooking appliance;

FIGS. 4-6 show counterweight movement during opening of the door;

FIGS. 7 and 8 show counterweight positioning along a depth of the oven;

FIG. 9 shows a bottom portion where the arm meets a lower end of the counterweight;

FIGS. 10 and 11 show the counterweight between a pair of guide rails; and

FIGS. 12 and 13 show an embodiment in which the counterweight includes a bearing strip to facilitate sliding or the arm along the counterweight.

### DETAILED DESCRIPTION

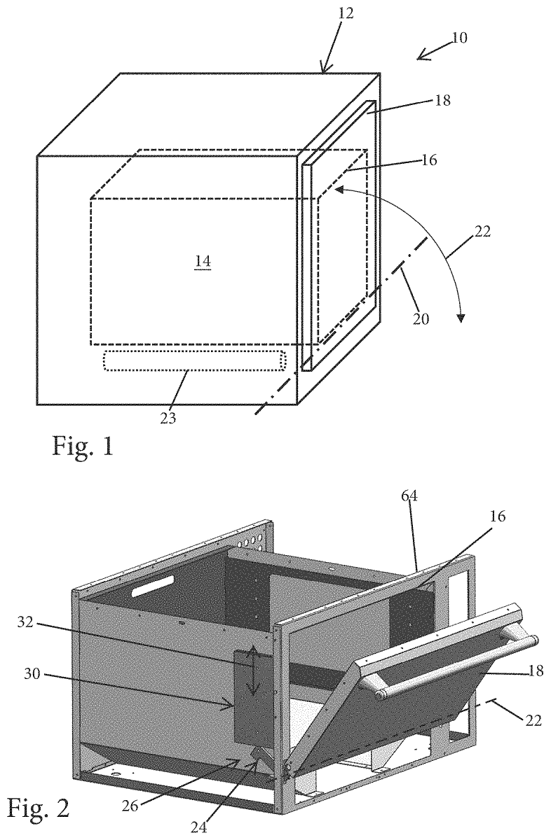

Referring to FIG. 1, a cooking appliance 10 is shown, which, by way of example may take the form of an oven or a range. As used herein, the term oven refers to appliances having a cooking chamber, but no cooktop. As used herein the term range refers to appliances having both a cooking chamber and a cooktop.

The appliance 10 includes a housing 12 (e.g., frame, external metal skins or panels and internal metal skins or panels) with an internal cooking chamber 14 accessible via a chamber opening 16. A door 18 is mounted adjacent the chamber opening and movable between a closed position closing the chamber opening and an open position in which items may be moved into and out of the cooking chamber 14. The door 18 is mounted to the housing for pivoting movement about a substantially horizontal pivot axis 20 between the closed position and the open position, per arrow 22. An exemplary gas burner 23 is shown below the cooking chamber 14, but electrical heaters or other heat sources could be used for heating the cooking chamber 14.

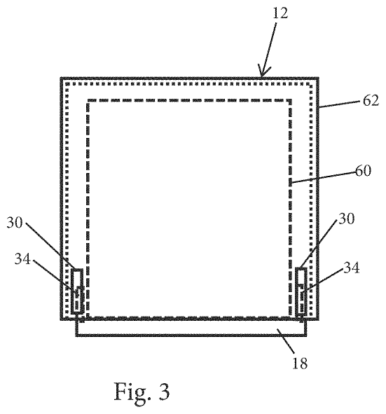

Per FIGS. 2 and 3, one or more cam arms 24 is/are connected to the door (e.g., at or near the bottom of the door near the side/sides of the door) and extend within the housing 12. Each cam arm 24 includes an inner end 26 that pivots about the substantially horizontal pivot axis 20 when the door 18 moves between the closed position and the open position.

A counterweight 30 is also disposed within the housing 12, external of the cooking chamber 14. The counterweight is mounted for linear movement along a path 32 alongside the cooking chamber 14. A portion of the cam arm 24 (e.g., a distal edge portion) is configured to movably (e.g., slidably) interact with the counterweight 30 such that the counterweight 30 is raised when the door 18 moves from the closed position to the open position.

Per FIG. 3, the appliance housing 12 includes an internal shell 60 (e.g., metal panels) that defines the cooking chamber 14 and an external shell 62 (e.g., metal panels) that defines an exterior surface of the cooking appliance 12. Here, the counterweight is located between the internal shell 60 and the external shell 62. A frame structure 64 (FIG. 2) of the housing 12 supports the shell components.

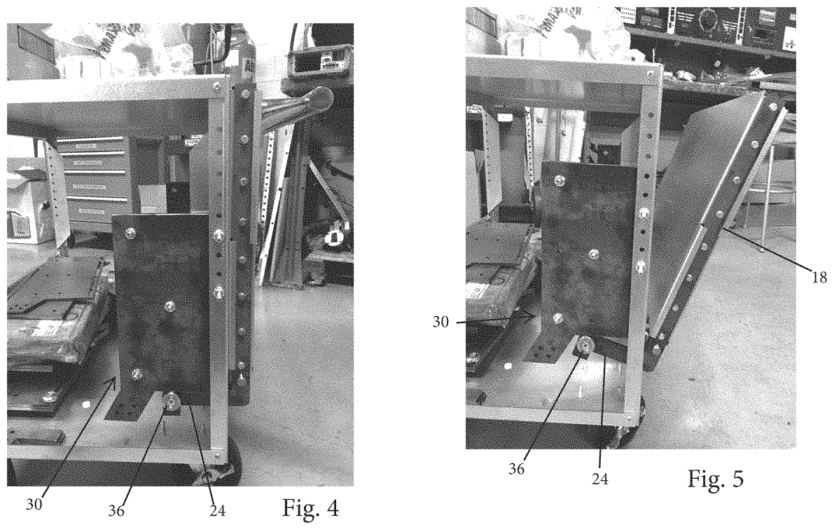

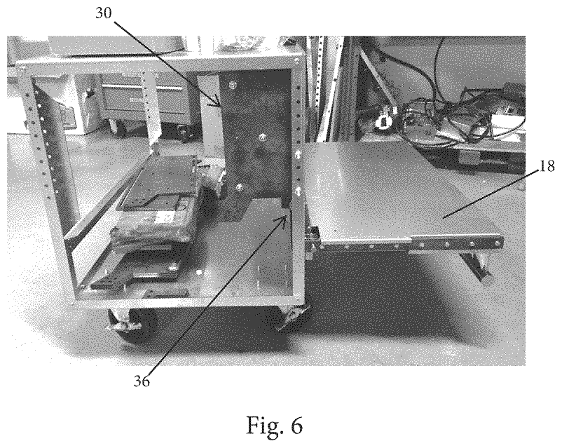

In embodiments, per FIGS. 4-6, the cam arm 24 includes a wheel member 36 that rollingly engages with counterweight 30, during the movement of the door 18, in order to raise and lower the counterweight.

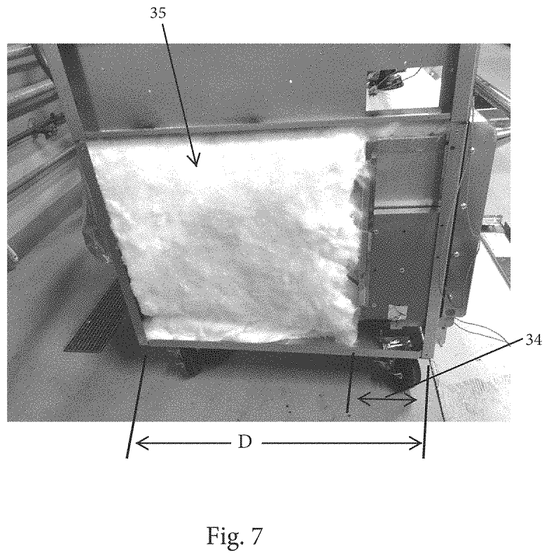

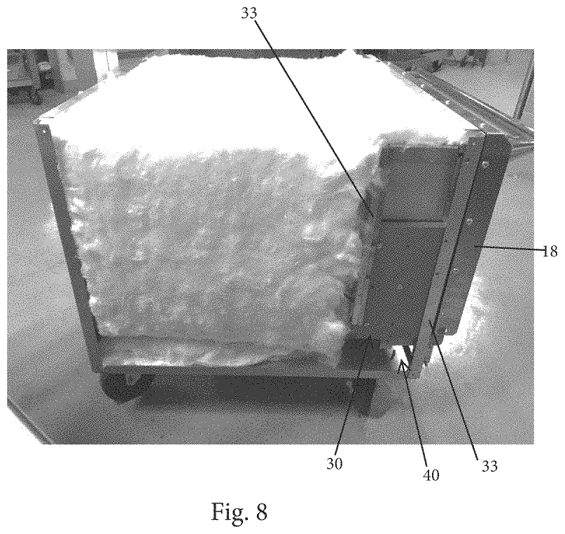

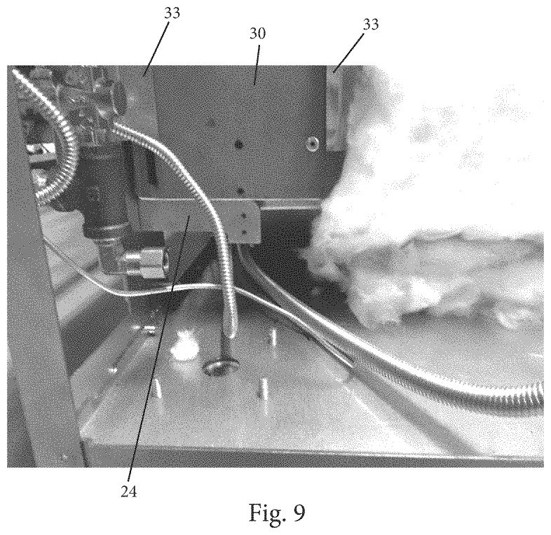

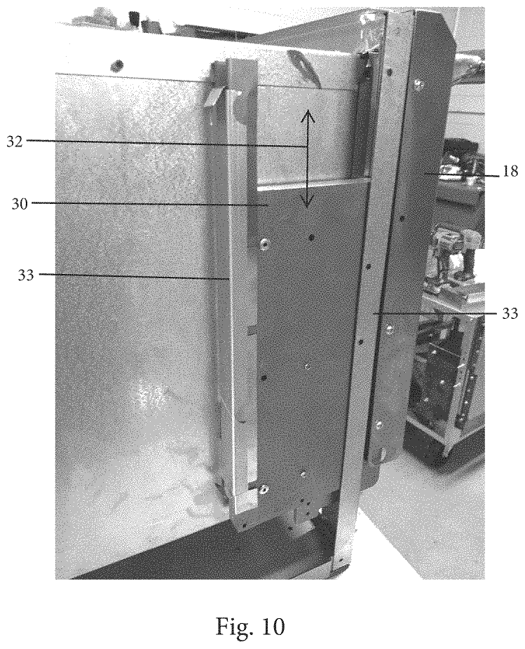

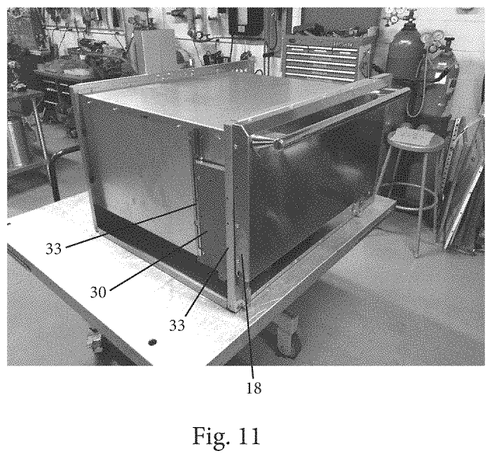

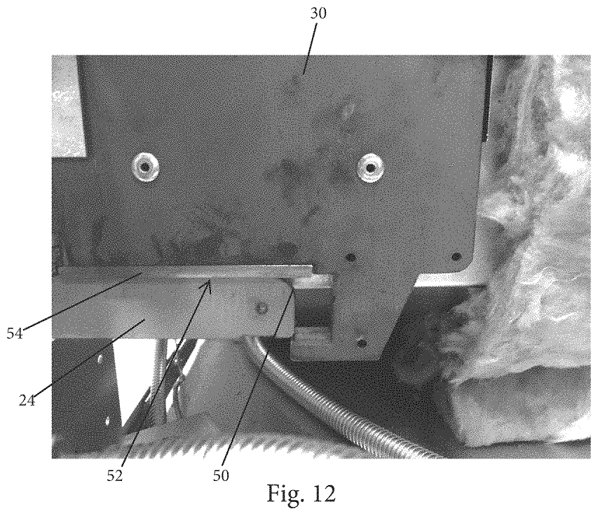

In some embodiments, per FIGS. 7-13, the counterweight 30 may be mounted between a set of guide rails 33 for linear movement, and the path 32 may be substantially vertical and between the guide rails as shown. Here, the substantially vertical path 32 is located along a front portion 34 of a side section of the housing. Preferably, a rear side or end of the front portion 34 extends no more than 33% (e.g., no more than 25%) of a depth D of the side section of the housing. This arrangement enables a large portion of the side section of the housing to incorporate insulation 35 at the exterior of the cavity, without interfering with movement of the counterweight during door opening and closing.

In the described embodiments, the cam arm 24 (e.g., some portion thereof, such as an edge or wheel member) contacts the counterweight but is not rigidly connected or fixed to the counterweight 30, enabling removal of the door without requiring any disconnection of the cam arm from the counterweight. This arrangement provides for simpler manufacture and also facilitates door maintenance when needed. In addition, at least ninety percent by weight of the counterweight 24 is above the portion of the cam arm over a full range of motion of the door from the closed position to open position. This arrangement provides a lower internal region 40, at the front of the appliance, along which wiring or piping may run.

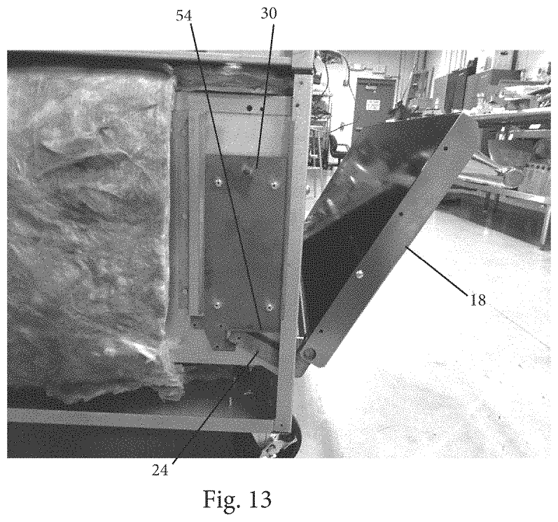

In embodiments, per FIGS. 12 and 13, a contoured surface portion 50 of the cam arm 24 slides along a slide surface 52 of the counterweight 24 when the door is moved from the closed position to the open position. For this purpose, the counterweight may include a bearing strip 54 that forms the slide surface 52. By way of example, a primary body 56 of the counterweight 24 may be steel (e.g. carbon steel) and the bearing strip 54 may be bronze. The cam arm may, for example, be steel or any material able to withstand applicable temperature conditions and cam forces.

When the door 18 is in a partly open condition, the counterweigh acts on the door arm, under gravity, to urge the door back toward the closed position. The counterweight also operates to maintain the door in the closed position. The described cam counterweight arrangement may offer certain benefits, such resulting in a narrow compact counterweight system profile, such that the frame can be optimized for use with either counterweights or conventional compression springs (Faringosi used on MD ranges), which will permit new Heavy Duty range size offerings such as 24″ and 2×30″ ovens on a 60″ platform. In addition, use of insulation can be maximized in the region directly behind (in the depthwise direction) the weight, with the weight configured to fit exactly for traverse and to maximize channel width. In addition, the weight is completely outside the cooking chamber. Moreover, the door can be easily installed/removed by pinning the weight(s) in open position, because the door arms and weights are not attached to each other. In embodiments, the weight is completely above the door arm, which provides open access for routing of gas train components (flex hose, thermocouples, etc.). The weights may also make use of the oven frame (or portions thereof) as the raceway/guide for slotted linear travel.

It is to be clearly understood that the above description is intended by way of illustration and example only, is not intended to be taken by way of limitation, and that other changes and modifications are possible. For example, each side of the door may include a respective cam arm and counterweight arrangement, per FIG. 3. However, in other embodiments, just one side of the door may include a cam arm and counterweight arrangement. Moreover, unless otherwise expressly indicated in any claim, the materials used can vary from those mentioned above.

What is claimed is:

1. A cooking appliance, comprising:
a housing with a cooking chamber accessible via a chamber opening;
a door mounted adjacent the chamber opening and movable between a closed position closing the chamber opening and an open position in which items may be moved into and out of the cooking chamber through the chamber opening, wherein the door is mounted to the housing for pivoting movement about a substantially horizontal pivot axis between the closed position and the open position;
a cam arm connected to the door and extending within the housing, wherein the cam arm includes an inner end that pivots about the substantially horizontal pivot axis when the door moves between the closed position and the open position;
a counterweight disposed within the housing and external of the cooking chamber, the counterweight mounted for linear movement along a path alongside the cooking chamber;
wherein a portion of the cam arm is configured to movably interact with the counterweight such that the counterweight is raised when the door moves from the closed position to the open position.

2. The cooking appliance of claim 1, further comprising a set of guide rails defining the path, wherein the counterweight is mounted between the set of guide rails, and the path is a substantially vertical path.

3. The cooking appliance of claim 2, wherein the substantially vertical path is located along a front portion of a side section of the housing.

4. The cooking appliance of claim 3, wherein a rear side of the front portion extends no more than 25% of a depth of the side section of the housing.

5. The cooking appliance of claim 1, wherein the portion of the cam arm comprises a wheel member that rollingly engages with the counterweight.

6. The cooking appliance of claim 1, wherein the cam arm contacts the counterweight but is not connected to the counterweight, enabling removal of the door without disconnection of the cam arm from the counterweight.

7. The cooking appliance of claim 1, wherein at least ninety percent by weight of the counterweight is above the portion of the cam arm over a full range of motion of the door from the closed position to open position.

8. The cooking appliance of claim 1, wherein a contoured surface portion of the cam arm slides along a slide surface of the counterweight when the door is moved from the closed position to the open position.

9. The cooking appliance of claim 8, wherein the counterweight carries a bearing strip that forms the slide surface.

10. The cooking appliance 9, wherein a primary body of the counterweight is steel and the bearing strip is bronze.

11. The cooking appliance of claim 10, wherein the cam arm is steel or aluminum.

12. The cooking appliance of claim 1, wherein the housing includes an internal shell that defines the cooking chamber and an external shell that defines an exterior surface of the cooking appliance, and wherein the counterweight is located between the internal shell and the external shell.

13. A cooking appliance, comprising:
a housing incorporating a cooking chamber accessible via a chamber opening;
a door mounted adjacent the chamber opening and movable between a closed position and an open position relative to the chamber opening;
a cam arm connected to the door and extending within the housing, wherein the cam arm moves with the door;
a counterweight disposed within the housing and external of the cooking chamber, the counterweight mounted for movement along a set path;
wherein a portion of the cam arm is configured to movably interact with the counterweight such that the counterweight is raised when the door moves from the closed position to the open position.

14. The cooking appliance of claim 13, further comprising a pair of spaced apart guide rails defining the set path, wherein the counterweight is mounted between the pair of guide rails, and the set path is a substantially vertical path.

15. The cooking appliance of claim 13, wherein the portion of the cam arm comprises a part that rollingly engages with the counterweight or a part that slidingly engages with the counterweight.

16. The cooking appliance of claim 13, wherein the cam arm contacts the counterweight but is not connected to the counterweight, enabling removal of the door without disconnection of the cam arm from the counterweight.

17. The cooking appliance of claim 13, wherein a contoured surface portion of the cam arm slides along a slide surface of the counterweight when the door is moved from the closed position to the open position, wherein the counterweight carries a bearing strip that forms the slide surface.

18. The cooking appliance of claim 13, wherein the housing includes an internal shell that defines the cooking chamber and an external shell that defines an exterior surface of the cooking appliance, and wherein the counterweight is located between the internal shell and the external shell.
